(19) United States
(12) Patent Application Publication
(10) Pub. No.: US 2009/0049949 A1
(43) Pub. Date: Feb. 26, 2009

(54) Bicycle handlebar

(76) Inventor: Chao-Hu Chen, Shengang Township (TW)

Correspondence Address: PHILLIP LIU, 6980, WHITEOAK DR., RICHMOND, BC, V7EAZ9, CA

(21) Appl. No.: 11/892,441

(22) Filed: Aug. 23, 2007

(51) Int. Cl. B62K 21/12

(52) U.S. Cl. 74/551.1

(57) ABSTRACT

A bicycle handlebar includes a mediate portion with two grip portions extending from two ends of the mediate portion, a reinforcement member is received in the mediate portion and securely in contact with an inner periphery of the mediate portion. The reinforcement member is made by carbon fibers or aluminum alloy so as to reinforce the strength of the mediate portion of the handlebar. The mediate portion is connected to the handlebar stem.

### FIELD OF THE INVENTION

The present invention relates to a bicycle handlebar which includes a reinforcement tube received in a mediate portion of the handlebar so as to reinforce the mediate portion of the handlebar.

### BACKGROUND OF THE INVENTION

A conventional bicycle handlebar generally made by metal material so as to have certain strength and includes a mediate portion and two grip portions which extend from two ends of the mediate portion. The mediate portion of the handlebar is connected to the handlebar stem and the user holes the two grip portions when riding the bicycle. Brake levers and gear swifter are located close to the grip portions. However, it is experienced that the handlebar is broken at the mediate portion which bears the most stress. To improve the shortcoming, some manufacturers increase the thickness of the handlebar and the thick handlebar increases the weight which is not satisfied by the users.

Some manufacturers weld two thinner tubes on two ends of a thicker tube which is used as the mediate portion of the handlebar. The welding portions affect the strength of the handlebar and tend to be broken by vibration.

The present invention intends to provide a bicycle handlebar which includes a reinforcement tube received in the mediate portion of the handlebar so that the handlebar is strong while the thickness of the mediate portion and the grip portions are the same.

### SUMMARY OF THE INVENTION

The present invention relates to a bicycle handlebar which comprises a mediate portion with two grip portions extending from two ends of the mediate portion. A reinforcement member is received in the mediate portion and securely in contact with an inner periphery of the mediate portion so as to obtain a strong mediate portion to which the handlebar stem is connected.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the handlebar and the reinforcement member in the mediate portion of the handlebar of the present invention;

FIG. 2 is a cross sectional view to show the handlebar of the present invention;

FIG. 2-1 is an end cross sectional view taken along line A-A in FIG. 2;

FIG. 2-2 is an end cross sectional view taken along line C-C in FIG. 2;

FIG. 2-3 is an end cross sectional view taken along line E-E in FIG. 2;

FIG. 3 is a cross sectional view to show the handlebar of the present invention wherein an end of the reinforcement member is circled as “G”;

FIG. 3-1 is an enlarged cross sectional view to show the portion circled by “G” in FIG. 3;

FIG. 4 shows that the handlebar stem is connected to the mediate portion of the handlebar of the present invention, and

FIG. 5 is a cross sectional view to show another embodiment of the handlebar of the present invention.

### DETAILED DESCRIPTION OF THE PREFERRED EMBODIMENT

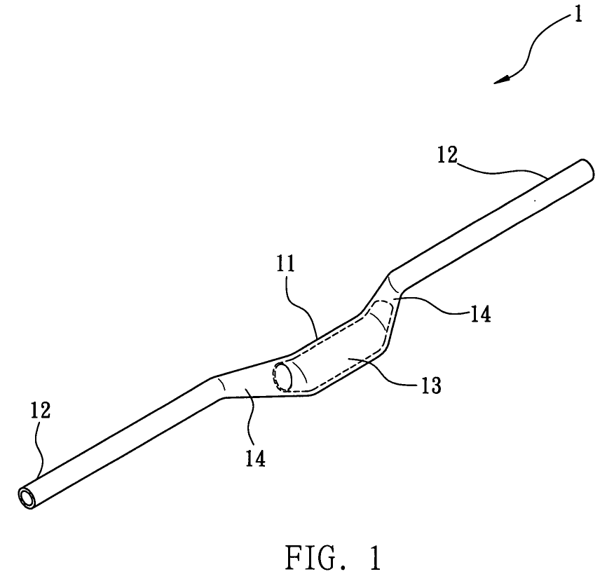

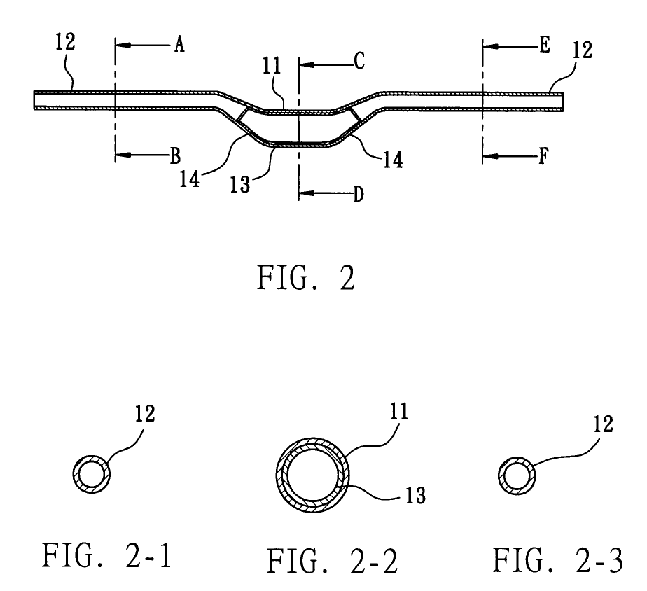

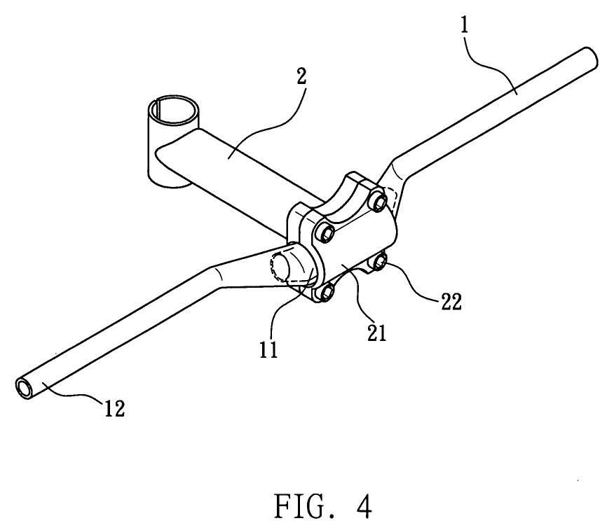

Referring to FIGS. 1, 2, 2-1, 2-2 and 2-3, the handlebar 1 of the present invention comprises a mediate portion 11 which includes two connection portions 14 on two ends thereof and two grip portions 12 are connected to the two connection portions 14. The mediate portion 11 is connected with a handlebar stem 2 as shown in FIG. 4 and the two grip portions 11 are connected with brake levers, gear swifter or the like which are not shown. The handlebar stem 2 includes a C-shaped clamp member 21 which clamp the mediate portion 21 by bolts 22. A diameter of the mediate portion 11 is larger than a diameter of the grip portions 12.

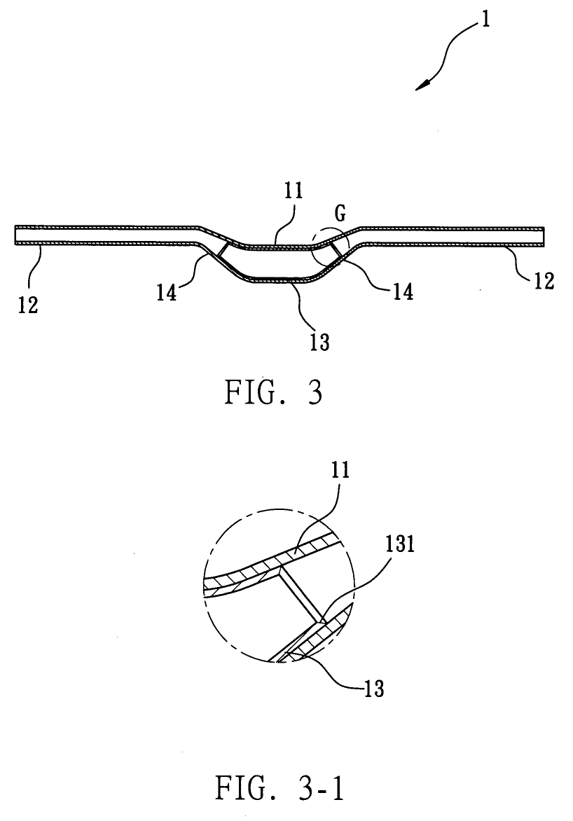

A reinforcement member 13 is received in the mediate portion 11 and securely in contact with an inner periphery of the mediate portion 13. The reinforcement member 13 is a tubular member and two end surface of the tubular member includes a tapered surface 131 as shown in FIGS. 3 and 3-1 so as to have better support feature. Two ends of the reinforcement member 13 are located within the connection portions 14. The reinforcement member 13 is made by carbon fibers or aluminum alloy. If the reinforcement member 13 is made by carbon fibers, the reinforcement member 13 can be glued to the inner periphery of the mediate portion 11. If the reinforcement member 13 is made by aluminum alloy, a hardness of the mediate portion 11 is less than a hardness of the reinforcement member 13, such that the reinforcement member 13 can be shrink slightly and received in the mediate portion 11.

A thickness of the mediate portion 11 is the same as a thickness of the grip portions 12, and a thickness of the reinforcement member 13 is not smaller than a thickness of the mediate portion 11. An axis of the mediate portion 11 and an axis of the grip portions 12 are parallel and separated by a distance.

It is noted that the handlebar 1 can be made by light metal such as aluminum alloy and the reinforcement member 13 is light so that the handlebar 1 is light and strong.

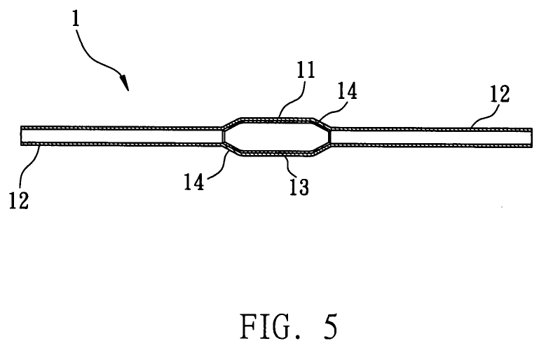

FIG. 5 shows another embodiment of the handlebar 1 of the present invention, wherein the mediate portion 11 and the grip portions 12 share a common axis.

While we have shown and described the embodiment in accordance with the present invention, it should be clear to those skilled in the art that further embodiments may be made without departing from the scope of the present invention.

What is claimed is:

1. A bicycle handlebar comprising:
a mediate portion with two grip portions extending from two ends of the mediate portion, and
a reinforcement member received in the mediate portion and securely in contact with an inner periphery of the mediate portion.

2. The handlebar as claimed in claim 1, wherein the reinforcement member is a tubular member and two end surface of the tubular member includes a tapered surface.

3. The handlebar as claimed in claim 1, wherein the reinforcement member is made by carbon fibers.

4. The handlebar as claimed in claim 1, wherein the reinforcement member is made by aluminum alloy.

5. The handlebar as claimed in claim 1, wherein a thickness of the mediate portion is the same as a thickness of the grip portions.

6. The handlebar as claimed in claim 1, wherein a thickness of the reinforcement member is not smaller than a thickness of the mediate portion.

7. The handlebar as claimed in claim 1, wherein the mediate portion includes two connection portions on two ends thereof and the two grip portions are connected to the two connection portions, two ends of the reinforcement member are located within the connection portions.

8. The handlebar as claimed in claim 1, wherein a hardness of the mediate portion is less than a hardness of the reinforcement member.

9. The handlebar as claimed in claim 1, wherein an axis of the mediate portion and an axis of the grip portions are parallel and separated by a distance.

10. The handlebar as claimed in claim 1, wherein the mediate portion and the grip portions share a common axis.
